(19) United States
(12) Patent Application Publication
(10) Pub. No.: US 2008/0155235 A1
(43) Pub. Date: Jun. 26, 2008

(54) Instructions Capable of Preventing Incorrect Usage of UContext Functions in a Multi-Process Environment

(76) Inventors: Douglas W. Dewey, Tucson, AZ (US); William G. Sherman, Tucson, AZ (US)

Correspondence Address: DILLON & YUDELL, LLP, 8911 N CAPITAL OF TEXAS HWY, SUITE 2110, AUSTIN, TX, 78759, US

(21) Appl. No.: 11/537,831

(22) Filed: Oct. 2, 2006

(51) Int. Cl. G06F 9/44

(52) U.S. Cl. 712/228

(57) ABSTRACT

An instruction capable of preventing incorrect usage of ucontext functions in a multi-process environment is disclosed. During an execution of a setcontext instruction, a determination is made whether or not a contextID of a context structure associated with a next context indicates that it is an original context of a process. If the contextID of the next context structure is an original context of a process, another determination is made whether or not the contextID of the context structure associated with the next context is the same as the original contextID of the process. If the contextID of the context structure associated with the next context is not the same as the original contextID of the process, an error recovery routine is invoked.

### BACKGROUND OF THE INVENTION

1. Technical Field

The present invention relates to ucontext functions in general, and in particular to a set of instructions for providing ucontext functions. Still more particularly, the present invention relates to a set of instructions capable of preventing incorrect usage of ucontext functions in a multi-process environment.

2. Description of Related Art

The UNIX® operating system provides a set of functions for handling context. Those context handling functions are often referred to as “ucontext” functions because they are provided via an ucontext.h file.

Specifically, the UNIX® operating system provides four ucontext function instructions, namely, getcontext, makecontext, setcontext, and swapcontext. The four ucontext function instructions may be modified for use in a kernel environment by multiple kernel processes that share the same code segment and address space. Because multiple processes can share the same code segment and address space, the same contexts may be utilized by more than one process.

The potential problem with one context that is capable of being executed by different processes at different times is that harmful and stealthy bugs may be inadvertently introduced in a code segment by a programmer who incorrectly uses ucontext function instructions within the code segment. Consequently, it would be desirable to provide a method for preventing incorrect usage of ucontext functions in a multi-process environment such that debugging effort can be minimized.

### SUMMARY OF THE INVENTION

In accordance with a preferred embodiment of the present invention, during an execution of a setcontext instruction, a determination is made whether or not a contextID of a context structure associated with a next context indicates that it is an original context of a process. If the contextID of the next context structure is not an original context of a process, the next context for the process is set by loading registers with values from the context structure associated with the next context. However, if the contextID of the next context structure is an original context of a process, another determination is made whether or not the contextID of the context structure associated with the next context is the same as the original contextID of the process. If the contextID of the context structure associated with the next context is the same as the original contextID of the process, the next context for the process is set by loading registers with values from the context structure associated with the next context. Otherwise, if the contextID of the context structure associated with the next context is not the same as the original contextID of the process, an error recovery routine is invoked.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a computer system in which a preferred embodiment of the present invention can be implemented; and

FIG. 2 is a high-level logical flow diagram of the additional functionalities provided by a setcontext instruction, in accordance with a preferred embodiment of the present invention.

### DETAILED DESCRIPTION OF A PREFERRED EMBODIMENT

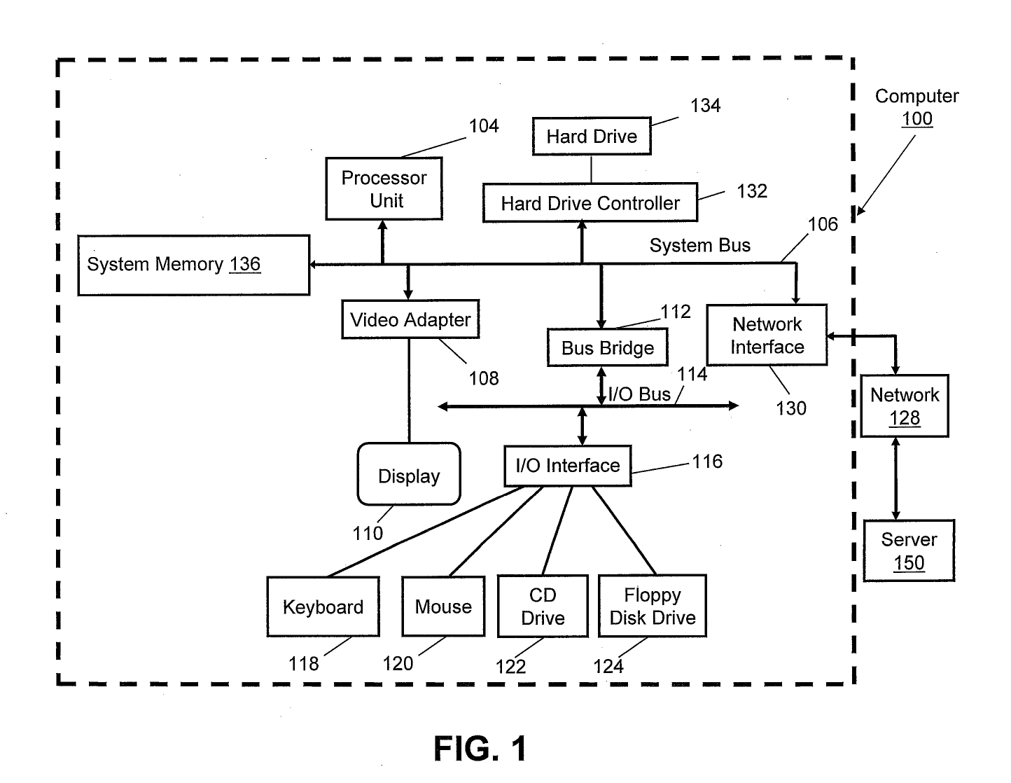

Referring now to the drawings, and specifically to FIG. 1, there is depicted a block diagram of a computer system in which a preferred embodiment of the present invention can be implemented. As shown, a computer 100 includes a processor 104 and a system memory 136, both are coupled to a system bus 106. Computer 100 also includes a hard drive controller 132, a video adapter 108, a bus bridge 112, and a network interface 130, all are coupled to system bus 106. Hard drive controller 132 controls a hard drive 134. Video adapter 108 drives a display 110. Bus bridge 112 is coupled to an input/output (I/O) interface 116 via an I/O bus 114. I/O interface 116 affords communication with various I/O devices, such as a keyboard 118, a mouse 120, a compact disk drive 122, and a floppy disk drive 124.

Computer 100 is capable of communicating with a server 150 via a network 128 using network interface 130. Network 128 may be an external network such as the Internet, or an internal network such as an Ethernet or a Virtual Private Network (VPN).

As utilized herein, a context refers to the current values of all registers within processor 104, and a context structure refers to a data structure within system memory 136 having multiple fields that may be used to store the value of each register within processor 104 at a given point in time. A context can be stored in a context structure having a stack pointer and user registers of a thread.

In accordance with a preferred embodiment of the present invention, a new set of ucontext function instructions that are capable of preventing incorrect usage of ucontext functions in a multi-process environment is provided. The new ucontext function instructions include getcontext, makecontext, setcontext, swapcontext and mycontextID.

The getcontext instruction is identical to the getcontext instruction provided under the UNIX® operating system.

As for the makecontext instruction, a new context identification (contextID) is assigned to the context being created when the makecontext instruction is executed, in addition to the intrinsic functionalities provided under the UNIX® operating system.

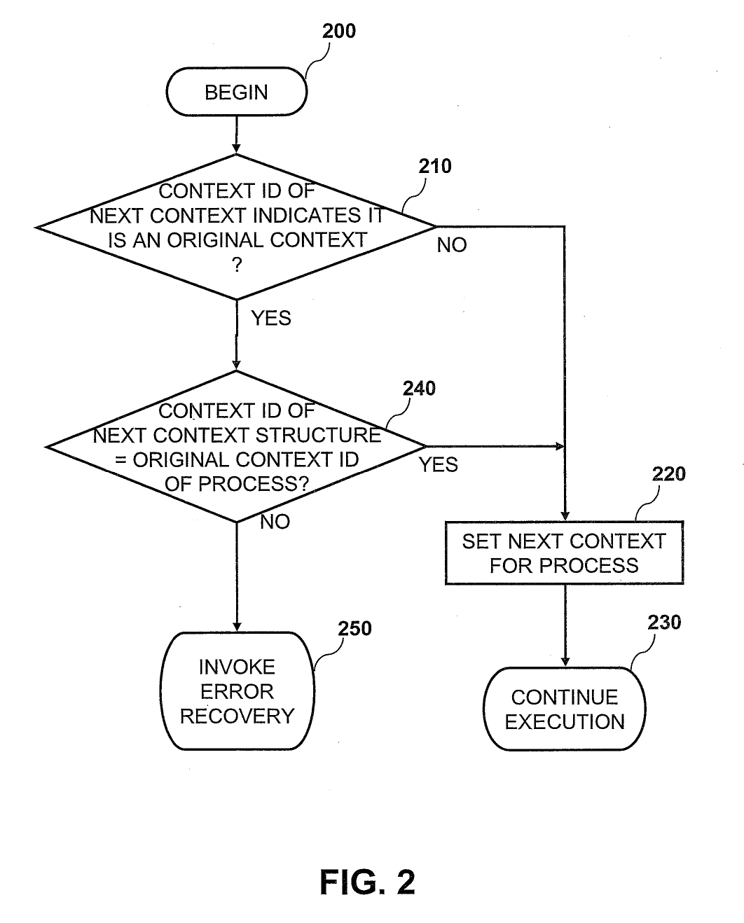

The setcontext instruction is also outfitted with additional functionalities in conjunction with the intrinsic functionalities provided under the UNIX® operating system. With reference now to FIG. 2, there is depicted a high-level logic flow diagram of the additional functionalities provided by the setcontext instruction, in accordance with a preferred embodiment of the present invention. Starting at block 200, before changing context of a process to a next context, a determination is made as to whether or not a contextID of a context structure associated with the next context indicates that it is an original context of a process, as shown in block 210. If the contextID of a next context structure is not an original context of a process, then the next context is set for the process by loading registers with values from the context structure associated with the next context, as depicted in block 220, and the execution of the code segment continues as normal, as shown in block 230.

Otherwise, if the contextID of a next context structure is an original context of a process, then another determination is made as to whether or not the contextID of the context structure associated with the next context is the same as the original contextID of the process, as depicted in block 240. If the contextID of the context structure associated with the next context is the same as the original contextID of the process, then the next context is set for the process by loading registers with values from the context structure associated with the next context, as depicted in block 220. Otherwise, if the contextID of the context structure associated with the next context is not the same as the original contextID of the process, then an error recovery routine should be invoked, as shown in block 250, because an incorrect context setting has occurred due to an incorrect of the setcontext instruction.

In most applications, a swapcontext instruction uses a setcontext instruction. When a setcontext instruction is called by a swapcontext instruction, the above-mentioned functionalities are also included in the swapcontext instruction.

The mycontextID instruction returns a contextID each time it is executed.

As has been described, the present invention provides a set of ucontext instructions that is capable of preventing incorrect usage ucontext functions in a multi-process environment.

It is also important to note that although the present invention has been described in the context of a fully functional computer system, those skilled in the art will appreciate that the mechanisms of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or compact disks and transmission type media such as analog or digital communications links.

While the invention has been particularly shown and described with reference to a preferred embodiment, it will be understood by those skilled in the art that various changes in form and detail may be made therein without departing from the spirit and scope of the invention.

What is claimed is:

1. A method for preventing incorrect usage of ucontext functions in a multi-process environment, said method comprising:
during an execution of a setcontext instruction, determining whether or not a contextID of a context structure associated with a next context indicates that it is an original context of a process;
in a determination that said contextID of said next context structure is not an original context of a process, setting said next context for said process by loading registers with values from said context structure associated with said next context;
in a determination that said contextID of said next context structure is an original context of a process, determining whether or not said contextID of said context structure associated with said next context is the same as said original contextID of said process; and
in a determination that said contextID of said context structure associated with said next context is not the same as said original contextID of said process, invoking an error recovery routine.

2. The method of claim 1, wherein said method further includes in a determination that said contextID of said context structure associated with said next context is the same as said original contextID of said process, setting said next context for said process by loading registers with values from said context structure associated with said next context.

3. The method of claim 1, wherein said method further includes returning a contextID each time during an execution of a mycontextID instruction.

4. The method of claim 1, wherein said method further includes assigning a new contextID each time during an execution of a makecontext instruction.

5. A computer usable medium having a computer program product for preventing incorrect usage of ucontext functions in a multi-process environment, said computer usable medium comprising:
program code means for determining whether or not a contextID of a context structure associated with a next context indicates that it is an original context of a process, during an execution of a setcontext instruction;
program code means for, in a determination that said contextID of said next context structure is not an original context of a process, setting said next context for said process by loading registers with values from said context structure associated with said next context;
program code means for, in a determination that said contextID of said next context structure is an original context of a process, determining whether or not said contextID of said context structure associated with said next context is the same as said original contextID of said process; and
program code means for, in a determination that said contextID of said context structure associated with said next context is not the same as said original contextID of said process, invoking an error recovery routine.

6. The computer usable medium of claim 5, wherein said computer usable medium further includes program code means for, in a determination that said contextID of said context structure associated with said next context is the same as said original contextID of said process, setting said next context for said process by loading registers with values from said context structure associated with said next context.

7. The computer usable medium of claim 5, wherein said computer usable medium further includes program code means for returning a contextID each time during an execution of a mycontextID instruction.

8. The computer usable medium of claim 5, wherein said computer usable medium further includes program code means for assigning a new contextID each time during an execution of a makecontext instruction.
